(19) United States
(12) Patent Application Publication
(10) Pub. No.: US 2022/0087249 A1
(43) Pub. Date: Mar. 24, 2022

(54) SOLUTION FOR PRESERVING BIOLOGICAL SAMPLES AND USE OF SUCH SOLUTION

(71) Applicant: KALTEK S.R.L., PADOVA (IT)

(72) Inventor: Lorenzo CORTELAZZO, PADOVA (IT)

(21) Appl. No.: 17/422,601

(22) PCT Filed: Nov. 25, 2019
(86) PCT No.: PCT/EP2019/082465

§ 371 Date: Jul. 13, 2021

(30) Foreign Application Priority Data
Jan. 16, 2019 (IT) 102019000000661

(51) Int. Cl. A01N 1/00; A01N 35/02

(52) U.S. Cl. CPC A01N 1/00; A01N 35/02

(57) ABSTRACT

A solution for preserving biological samples, includes methyl ethyl ketone peroxide with a percentage by volume between 5% and 25%. There is also a use of a solution for preserving biological samples including methyl ethyl ketone peroxide with a percentage by volume between 5% and 25%. The use includes immersing the sample in the solution.

### TECHNICAL FIELD

The present disclosure relates to a solution for preserving biological samples.

The disclosure also relates to the use of such solution.

### BACKGROUND

Nowadays, the need is widespread to preserve biological samples, for example in order to be able to conduct diagnostic tests, in hospitals, possibly weeks after the samples were taken.

For the preservation both of cadavers and of biological samples, the use is known of substances like formalin, a solution based on formaldehyde.

The formalin usually used for the preservation of tissues is an aqueous solution containing 37-50% by volume of formaldehyde and 10-15% by volume of methanol, used as a stabilizer.

This solution is then diluted to 5-10% by volume for use.

Such known art has some drawbacks.

Formaldehyde is an irritant to the eyes and skin and it can generate dermatitis.

It has also been shown that formaldehyde, depending on the concentration, can cause irritation of the air pathways, sensations of suffocation, pulmonary edema, asthma, alteration of respiratory function, cancer and leukemia.

Furthermore, long-term exposure to concentrations of methanol vapors can cause metabolic acidosis and blindness.

In order to overcome such drawbacks, an alternative solution to formalin has been developed and is established on the market, one that does not present problems of toxicity and which is not carcinogenic.

This solution is based on methyl ethyl ketone peroxide (MEKP) with a concentration by volume usually higher than 30%.

However, this solution also has some drawbacks.

Methyl ethyl ketone peroxide is highly explosive, corrosive, and is an irritant to the skin.

These characteristics are progressively more accentuated as the concentration by volume of solution increases, in particular for percentages by volume of solution higher than 30%.

### SUMMARY

The aim of the present disclosure is to provide a solution for preserving biological samples which is capable of improving the known art in one or more of the above mentioned aspects.

Within this aim, the disclosure provides a solution for preserving biological samples that is not carcinogenic or toxic for the user and which is less explosive and less corrosive than the solutions known today.

The disclosure further provides a solution for preserving biological samples that is highly reliable, easy to implement and low cost.

This aim and these and other advantages which will become better apparent hereinafter are achieved by providing a solution for preserving biological samples, which is characterized in that it comprises methyl ethyl ketone peroxide with a percentage by volume comprised between 5% and 25%.

Further characteristics and advantages of the disclosure will become better apparent from the detailed description that follows of a preferred, but not exclusive, embodiment of the solution according to the disclosure, which is illustrated in the following description.

### DETAILED DESCRIPTION OF THE DISCLOSURE

A solution for preserving biological samples according to the disclosure comprises methyl ethyl ketone peroxide with a percentage by volume comprised between 5% and 25%.

In this manner, the risks of explosion and corrosion are reduced with respect to conventional solutions.

In a preferred embodiment, the methyl ethyl ketone peroxide of the solution has a percentage by volume of 10%.

Such solution also comprises dimethyl sulfoxide.

In a preferred embodiment of the solution, the dimethyl sulfoxide has a percentage by volume of 90%.

Dimethyl sulfoxide has no contraindications, unlike methyl ethyl ketone peroxide, therefore the higher its percentage by volume and the lower that of methyl ethyl ketone peroxide, the lower the risks of explosion or corrosion.

Experimental tests and trials in the field have shown that a percentage by volume in a solution of methyl ethyl ketone peroxide comprised between 5% and 25% is sufficient to preserve biological samples.

The solution according to the present disclosure can comprise other elements in addition to methyl ethyl ketone peroxide and dimethyl sulfoxide, such as one or more organic solvents, such as for example glycerol and/or liquid petrolatum, and water.

In a preferred embodiment, the solution has a composition constituted solely by:

10% by volume of methyl ethyl ketone peroxide,

90% by volume of dimethyl sulfoxide.

The disclosure also relates to the use of a solution like the one described above for preserving biological samples.

In the present description, the term “preserving” means slowing down the processes of chemical/physical deterioration that begin as a consequence of the removal of biological samples or of the death of the organism from which the biological sample in question is removed.

In the present description, the expression “biological sample” means any organ, cell, tissue or even entire organism that needs to be preserved.

A first form of use of a solution, as described previously, entails the immersion of the biological sample inside such solution.

A second form of use of a solution, as described previously, entails a superficial application of such solution on the biological sample, for example by way of spreading.

A third form of use of a solution, as described previously, entails an inoculation of such solution inside vascular and/or anatomical cavities of the biological sample.

In practice it has been found that the disclosure fully achieves the intended aim and advantages by providing a solution for preserving biological samples that is not carcinogenic or toxic for the user and which is less explosive and less corrosive than the solutions known today.

The disclosure thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102019000000661 from which this application claims priority are incorporated herein by reference.

1-10. (canceled)

11. A solution for preserving biological samples, comprising methyl ethyl ketone peroxide with a percentage by volume comprised between 5% and 25%.

12. The solution according to claim 11, further comprising dimethyl sulfoxide.

13. The solution according to claim 11, wherein said methyl ethyl ketone peroxide has a percentage by volume of 10%.

14. The solution according to claim 12, wherein said dimethyl sulfoxide has a percentage by volume of 90%.

15. The solution according to claim 11, further comprising one or more organic solvents.

16. The solution according to claim 11, further comprising water.

17. Use of a solution for preserving biological samples according to claim 11.

18. The use according to claim 17, wherein a biological sample is immersed in said solution.

19. The use according to claim 17, wherein said solution is applied superficially on a biological sample.

20. The use according to claim 17, wherein said solution is inoculated inside vascular and/or anatomical cavities of a biological sample.
